(19) United States
(12) Patent Application Publication
(10) Pub. No.: US 2025/0310882 A1
(43) Pub. Date: Oct. 2, 2025

(54) LOW POWER WAKE-UP SIGNAL FOR RADIO RESOURCE CONTROL CONNECTED MODE

(71) Applicant: QUALCOMM Incorporated, San Diego, CA (US)

(72) Inventors: Jung Ho RYU, Englewood Cliffs, NJ (US); Igor GUTMAN, Hod HaSharon (IL); Kazuki TAKEDA, Minato-ku (JP); Hemant SAGGAR, San Diego, CA (US)

(21) Appl. No.: 19/041,079

(22) Filed: Jan. 30, 2025

Related U.S. Application Data
(60) Provisional application No. 63/573,160, filed on Apr. 2, 2024.

(51) Int. Cl. H04W 52/02; H04B 7/06; H04B 7/08; H04L 5/00

(52) U.S. Cl. CPC H04W 52/0235; H04B 7/0626; H04B 7/088; H04L 5/0005

(57) ABSTRACT

Methods, systems, and devices for wireless communications are described. A user equipment (UE) may receive, via a low power wake-up receiver (LP-WUR), a low power wake-up signal (LP-WUS) that may be indicative that the UE is to switch from use of the LP-WUR to a main receiver (MR), where the LP-WUR may be limited with respect to the MR. In some examples, the LP-WUS may also include control information. In some examples, the UE may switch the MR to an on state based on receiving the LP-WUS, via the LP-WUR. The control information may be associated with an MR wake-up indication, channel state information reporting, beam switching, transmission configuration indication activation or deactivation, synchronization signal transmissions, a random access procedure, or a combination thereof. The UE may perform, after switching the MR to the on state, one or more operations associated with the control information indicated in the LP-WUS.

### RELATED APPLICATIONS

This patent application claims priority to U.S. Patent Application No. 63/573,160, entitled “LOW POWER WAKE-UP SIGNAL FOR RADIO RESOURCE CONTROL CONNECTED MODE” and filed Apr. 2, 2024, assigned to the assignee hereof and hereby expressly incorporated by reference herein.

### FIELD OF TECHNOLOGY

The following relates to wireless communications, including a low power wake-up signal (LP-WUS) for radio resource control (RRC) connected mode.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

A method for wireless communications by a user equipment (UE) is described. The method may include receiving, via a first radio, a low power wake-up signal (LP-WUS) that is indicative that the UE is to switch from use of the first radio to a second radio, where the LP-WUS also includes control information, and where the first radio is limited with respect to the second radio, switching the second radio to an on state based on receiving, via the first radio, the LP-WUS, and performing, after switching the second radio to the on state, one or more operations associated with the control information indicated in the LP-WUS.

A UE for wireless communications is described. The UE may include one or more memories storing processor executable code, and one or more processors coupled with the one or more memories. The one or more processors may individually or collectively be operable to execute the code to cause the UE to receive, via a first radio, a LP-WUS that is indicative that the UE is to switch from use of the first radio to a second radio, where the LP-WUS also includes control information, and where the first radio is limited with respect to the second radio, switch the second radio to an on state based on receiving, via the first radio, the LP-WUS, and perform, after switching the second radio to the on state, one or more operations associated with the control information indicated in the LP-WUS.

Another UE for wireless communications is described. The UE may include means for receiving, via a first radio, a LP-WUS that is indicative that the UE is to switch from use of the first radio to a second radio, where the LP-WUS also includes control information, and where the first radio is limited with respect to the second radio, means for switching the second radio to an on state based on receiving, via the first radio, the LP-WUS, and means for performing, after switching the second radio to the on state, one or more operations associated with the control information indicated in the LP-WUS.

A non-transitory computer-readable medium storing code for wireless communications is described. The code may include instructions executable by one or more processors to receive, via a first radio, a LP-WUS that is indicative that the UE is to switch from use of the first radio to a second radio, where the LP-WUS also includes control information, and where the first radio is limited with respect to the second radio, switch the second radio to an on state based on receiving, via the first radio, the LP-WUS, and perform, after switching the second radio to the on state, one or more operations associated with the control information indicated in the LP-WUS.

Some examples of the method, UEs, and non-transitory computer-readable medium described herein may further include operations, features, means, or instructions for receiving, prior to receiving the LP-WUS, a control message that assigns an identifier to the UE, where the control information in the LP-WUS further indicates the identifier.

In some examples of the method, UEs, and non-transitory computer-readable medium described herein, the identifier may be exclusively assigned to the UE or to a set of UEs.

In some examples of the method, UEs, and non-transitory computer-readable medium described herein, the control information indicated in the LP-WUS includes a wake-up bit that may have one of a first value or a second value, the first value of the wake-up bit indicates for the UE to switch the second radio to the on state, and the second value of the wake-up bit indicates for the UE to switch the second radio to an off state.

Some examples of the method, UEs, and non-transitory computer-readable medium described herein may further include operations, features, means, or instructions for receiving a configuration message that indicates for the UE to monitor for one or more LP-WUSs using the second radio.

In some examples of the method, UEs, and non-transitory computer-readable medium described herein, the control information indicated in the LP-WUS includes one or more channel state information bits and the method, UEs, and non-transitory computer-readable medium may include further operations, features, means, or instructions for transmitting, as part of the one or more operations, a channel state information report based on the control information indicated in the LP-WUS including the one or more channel state information bits.

In some examples of the method, UEs, and non-transitory computer-readable medium described herein, the one or more channel state information bits further indicate one or more time resources and one or more frequency resources for transmission of the channel state information report.

In some examples of the method, UEs, and non-transitory computer-readable medium described herein, the control information indicated in the LP-WUS includes one or more beam switch bits and the method, UEs, and non-transitory computer-readable medium may include further operations, features, means, or instructions for switching, as part of the one or more operations, from a first beam associated with communications with a network entity to a second beam associated with communications with the network entity.

In some examples of the method, UEs, and non-transitory computer-readable medium described herein, the one or more beam switch bits further indicate the second beam.

In some examples of the method, UEs, and non-transitory computer-readable medium described herein, the control information indicated in the LP-WUS includes a synchronization signal transmission bit that indicates a synchronization signal to be transmitted by a network entity and the method, UEs, and non-transitory computer-readable medium may include further operations, features, means, or instructions for receiving, as part of the one or more operations, the synchronization signal from the network entity.

In some examples of the method, UEs, and non-transitory computer-readable medium described herein, the control information indicated in the LP-WUS includes a sounding reference signal bit that indicates for the UE to transmit a sounding reference signal and the method, UEs, and non-transitory computer-readable medium may include further operations, features, means, or instructions for transmitting, as part of the one or more operations, the sounding reference signal based on the control information indicated in the LP-WUS including the sounding reference signal bit.

In some examples of the method, UEs, and non-transitory computer-readable medium described herein, the control information indicated in the LP-WUS includes a physical downlink control channel order bit that indicates for the UE to transmit a physical random access channel message to a network entity and the method, UEs, and non-transitory computer-readable medium may include further operations, features, means, or instructions for transmitting, as part of the one or more operations, the physical random access channel message to the network entity based on the control information indicated in the LP-WUS including the physical downlink control channel order bit.

In some examples of the method, UEs, and non-transitory computer-readable medium described herein, the physical random access channel message includes uplink timing synchronization information.

In some examples of the method, UEs, and non-transitory computer-readable medium described herein, switching, after performing the one or more operations, the second radio to an off state in accordance with an LP-WUS procedure.

In some examples of the method, UEs, and non-transitory computer-readable medium described herein, the UE switches the second radio to the off state after a configured duration in accordance with the LP-WUS procedure.

Some examples of the method, UEs, and non-transitory computer-readable medium described herein may further include operations, features, means, or instructions for receiving the control information as one or more information bits associated with one or more parameters of the LP-WUS, the one or more parameters including an on-off keying waveform, a spreading sequence for portions of the on-off keying waveform, a distribution of one or more time resources associated with the portions of the on-off keying waveform, a distribution of one or more frequency resources associated with the portions of the on-off keying waveform, or a combination thereof.

In some examples of the method, UEs, and non-transitory computer-readable medium described herein, the first radio may be a low power-wake up receiver (LP-WUR) and the second radio may be a main receiver (MR).

A method for wireless communications by a network entity is described. The method may include transmitting a configuration message that indicates for a UE to monitor for one or more LP-WUSs and transmitting a LP-WUS that is indicative that the UE is to switch from use of a first radio to a second radio, where the LP-WUS also includes control information, and where the first radio is limited with respect to the second radio.

A network entity for wireless communications is described. The network entity may include one or more memories storing processor executable code, and one or more processors coupled with the one or more memories. The one or more processors may individually or collectively be operable to execute the code to cause the network entity to transmit a configuration message that indicates for a UE to monitor for one or more LP-WUSs and transmit a LP-WUS that is indicative that the UE is to switch from use of a first radio to a second radio, where the LP-WUS also includes control information, and where the first radio is limited with respect to the second radio.

Another network entity for wireless communications is described. The network entity may include means for transmitting a configuration message that indicates for a UE to monitor for one or more LP-WUSs and means for transmitting a LP-WUS that is indicative that the UE is to switch from use of a first radio to a second radio, where the LP-WUS also includes control information, and where the first radio is limited with respect to the second radio.

A non-transitory computer-readable medium storing code for wireless communications is described. The code may include instructions executable by one or more processors to transmit a configuration message that indicates for a UE to monitor for one or more LP-WUSs and transmit a LP-WUS that is indicative that the UE is to switch from use of a first radio to a second radio, where the LP-WUS also includes control information, and where the first radio is limited with respect to the second radio.

Some examples of the method, network entities, and non-transitory computer-readable medium described herein may further include operations, features, means, or instructions for transmitting, prior to receiving the LP-WUS, a control message that assigns an identifier to the UE, where the control information in the LP-WUS further indicates the identifier.

In some examples of the method, network entities, and non-transitory computer-readable medium described herein, the identifier may be exclusively assigned to the UE or to a set of UEs.

In some examples of the method, network entities, and non-transitory computer-readable medium described herein, the control information indicated in the LP-WUS includes a wake-up bit that may have one of a first value or a second value, the first value of the wake-up bit indicates for the UE to switch the second radio to an on state, and the second value of the wake-up bit indicates for the UE to switch the second radio to an off state.

In some examples of the method, network entities, and non-transitory computer-readable medium described herein, the control information indicated in the LP-WUS includes one or more channel state information bits and the method, UEs, and non-transitory computer-readable medium may include further operations, features, means, or instructions for receiving a channel state information report based on the control information indicated in the LP-WUS including the one or more channel state information bits.

In some examples of the method, network entities, and non-transitory computer-readable medium described herein, the one or more channel state information bits further indicate one or more time resources and one or more frequency resources for transmission at the UE of the channel state information report.

In some examples of the method, network entities, and non-transitory computer-readable medium described herein, the control information indicated in the LP-WUS includes one or more beam switch bits that indicates for the UE to switch from a first beam associated with communications with a network entity to a second beam associated with communications with the network entity.

In some examples of the method, network entities, and non-transitory computer-readable medium described herein, the one or more beam switch bits further indicate the second beam.

In some examples of the method, network entities, and non-transitory computer-readable medium described herein, the control information indicated in the LP-WUS includes a synchronization signal transmission bit that indicates a synchronization signal to be transmitted by a network entity and the method, UEs, and non-transitory computer-readable medium may include further operations, features, means, or instructions for transmitting, to the UE, the synchronization signal.

In some examples of the method, network entities, and non-transitory computer-readable medium described herein, the control information indicated in the LP-WUS includes a sounding reference signal bit that indicates for the UE to transmit a sounding reference signal and the method, UEs, and non-transitory computer-readable medium may include further operations, features, means, or instructions for receiving the sounding reference signal based on the control information indicated in the LP-WUS including the sounding reference signal bit.

In some examples of the method, network entities, and non-transitory computer-readable medium described herein, the control information indicated in the LP-WUS includes a physical downlink control channel order bit that indicates for the UE to transmit a physical random access channel message to the network entity and the method, UEs, and non-transitory computer-readable medium may include further operations, features, means, or instructions for receiving, from the UE, the physical random access channel message based on the control information indicated in the LP-WUS including the physical downlink control channel order bit.

In some examples of the method, network entities, and non-transitory computer-readable medium described herein, the physical random access channel message includes uplink timing synchronization information.

Some examples of the method, network entities, and non-transitory computer-readable medium described herein may further include operations, features, means, or instructions for transmitting the control information as one or more information bits associated with one or more parameters of the LP-WUS, the one or more parameters including an on-off keying waveform, a spreading sequence for portions of the on-off keying waveform, a distribution of one or more time resources associated with the portions of the on-off keying waveform, a distribution of one or more frequency resources associated with the portions of the on-off keying waveform, or a combination thereof.

In some examples of the method, network entities, and non-transitory computer-readable medium described herein, the first radio may be a LP-WUR and the second radio may be a MR.

### BRIEF DESCRIPTION OF THE DRAWINGS

FIG. 1 shows an example of a wireless communications system that supports a low power wake-up signal (LP-WUS) for radio resource control (RRC) connected mode in accordance with one or more aspects of the present disclosure.

FIG. 2 shows an example of a wireless communications system that supports a LP-WUS for RRC connected mode in accordance with one or more aspects of the present disclosure.

FIG. 3 shows an example of a LP-WUS transmission for RRC connected mode in accordance with one or more aspects of the present disclosure.

FIG. 4 shows an example of a process flow that supports a LP-WUS for RRC connected mode in accordance with one or more aspects of the present disclosure.

FIGS. 5 and 6 show block diagrams of devices that support a LP-WUS for RRC connected mode in accordance with one or more aspects of the present disclosure.

FIG. 7 shows a block diagram of a communications manager that supports a LP-WUS for RRC connected mode in accordance with one or more aspects of the present disclosure.

FIG. 8 shows a diagram of a system including a device that supports a LP-WUS for RRC connected mode in accordance with one or more aspects of the present disclosure.

FIGS. 9 and 10 show block diagrams of devices that support a LP-WUS for RRC connected mode in accordance with one or more aspects of the present disclosure.

FIG. 11 shows a block diagram of a communications manager that supports a LP-WUS for RRC connected mode in accordance with one or more aspects of the present disclosure.

FIG. 12 shows a diagram of a system including a device that supports a LP-WUS for RRC connected mode in accordance with one or more aspects of the present disclosure.

FIGS. 13 through 16 show flowcharts illustrating methods that support a LP-WUS for RRC connected mode in accordance with one or more aspects of the present disclosure.

### DETAILED DESCRIPTION

In some examples of wireless communications, a user equipment (UE) may operate in one or more modes to reduce power expenditure. For example, the UE may transition to a low power mode, in which the UE may turn off a main receiver (MR) used for primary communications at the UE. As such, the UE may use a low power wake-up receiver (LP-WUR) to monitor for one or more low power wake-up signal (LP-WUSs) and low power synchronization signals (LP-SSs). In some examples, the LP-WUS may be a low-complexity radio signal used to indicate for the UE to turn on the MR to perform one or more operations. For instance, if a network entity has determined to schedule the UE for wireless communications, the network entity may transmit an LP-WUS to the UE indicating for the UE to turn on the MR and monitor physical downlink control channel (PDCCH). As such, the use of LP-WUR for frequency range 1 (FR1) may allow the UE to reduce power expenditure at the MR. In some cases, however, the low-complexity nature of the LP-WUR may reduce reliability for communications via frequency range 2 (FR2). For example, LP-WUS based procedures for FR2 may be associated with beam pair maintenance and management. In some examples, such beam pair communications were handled via control messages which may be associated with a signal structure that the LP-WUR may be unable to decode.

Various aspects relate generally to wireless communication and more particularly to the communication of control information via LP-WUSs. Some aspects more specifically relate to the network entity and the UE configuring an LP-WUS to indicate a set of bits corresponding to control information using an on-off keying (OOK) waveform, where an OOK waveform may be received and decoded by the LP-WUR. In some examples, the control information bits may indicate one or more respective types of operations for the UE to perform in accordance with the MR. For example, the control information bits may be associated with an MR wake-up indication, channel state information (CSI) reporting, beam switching, transmission configuration indication activation or deactivation, synchronization signal transmissions, random access procedures, or a combination thereof. After completion of the one or more operations indicated by the control information bits, the UE may switch the MR back to an off state, thereby reducing power expenditure at the UE.

Particular aspects of the subject matter described in this disclosure may be implemented to realize one or more of the following potential advantages. In some examples, by including control information in an LP-WUS, the described techniques may be used to reduce the duration the MR of the UE is in an on state. More specifically, the UE may use the LP-WUR to receive control information regarding the performance of one or more operations, where the LP-WUR may expend less power compared to the MR based on the low-complexity structure of the LP-WUR. Such reductions in MR usage may increase energy efficiency at the UE. As such, the aspects of the present disclosure may achieve reduction in power usage by the UE, which may increase the life and longevity of a power source associated with the UE.

Aspects of the disclosure are initially described in the context of wireless communications systems, a LP-WUS transmission, and a process flow. Aspects of the disclosure are further illustrated by and described with reference to apparatus diagrams, system diagrams, and flowcharts that relate to LP-WUS for radio resource control (RRC) connected mode.

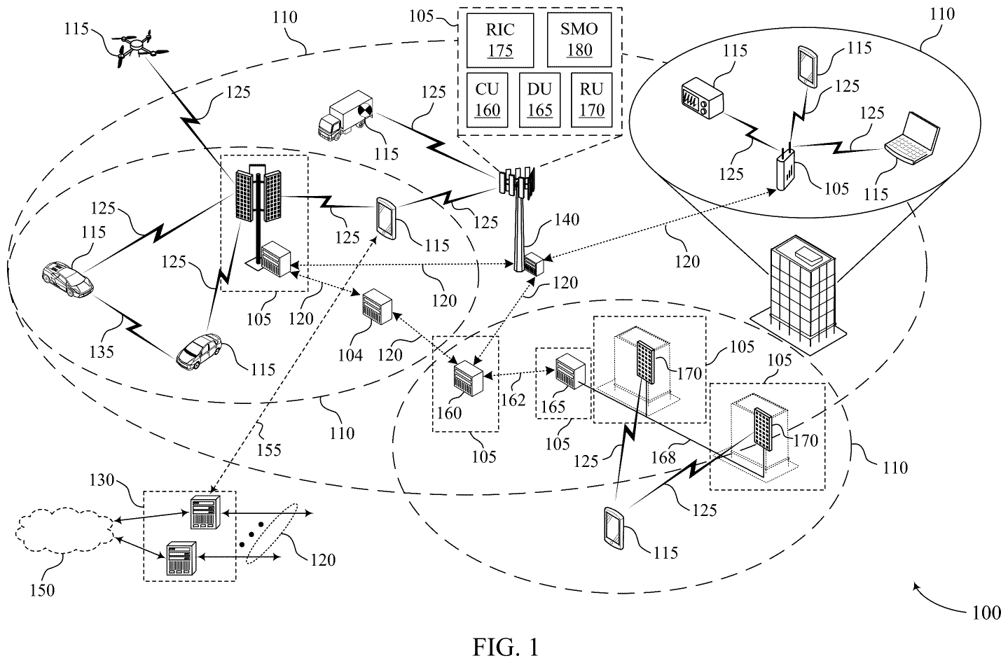

FIG. 1 shows an example of a wireless communications system 100 that supports LP-WUS for RRC connected mode in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Ne may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, LP-WUSs, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a CSI reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, low power wakeup signal (LP-WUS) or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets, or transmission configuration indication states, or receive spatial filters) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions). In some other examples, a receiving device (e.g., a UE 115) may receive one or more control signals (e.g., LP-WUS) using an LP-WUR by applying one or more beamforming weight sets to multiple antenna elements of an antenna array associated with the receiving device. In some cases, the receiving device may adjust the beamforming weights used to receive a control signal to improve a received signal quality of the control signal. The adjustment of beamforming weights may be based on a control signal from the network (e.g., a network entity 105). The receiving device may adjust the LP-WUR beamforming weights over time, where one or more first beamforming weights used at one instance of time may be different from one or more second beamforming weights used at another instance of time. The receiving device may use one or more sets of beamforming weights concurrently (or simultaneously) to receive control signals from one or more spatial directions. The beamforming weights applied by LP-WUR to receive control signals may be based on the beamforming weights used by an MR of the receiving device (e.g., used to receive reference signals from the network).

In some examples, wireless communications system 100 may relate generally to wireless communication and more particularly to the communication of control information via LP-WUSs. Some aspects more specifically relate to a network entity 105 and the UE 115 configuring an LP-WUS to indicate a set of bits corresponding to control information using an OOK waveform, where an OOK waveform may be received and decoded by an LP-WUR at the UE 115. In some examples, the control information bits may indicate one or more respective types of operations for the UE 115 to perform in accordance with the MR. For example, the control information bits may be associated with an MR wake-up indication, CSI reporting, beam switching, synchronization signal transmissions, random access procedures, or a combination thereof. After completion of the one or more operations indicated by the control information bits, the UE 115 may switch the MR back to an off state, thereby reducing power expenditure at the UE 115. Such aspects of the present disclosure may achieve reduction in power usage by the UE 115, which may increase the life and longevity of a power source associated with the UE 115.

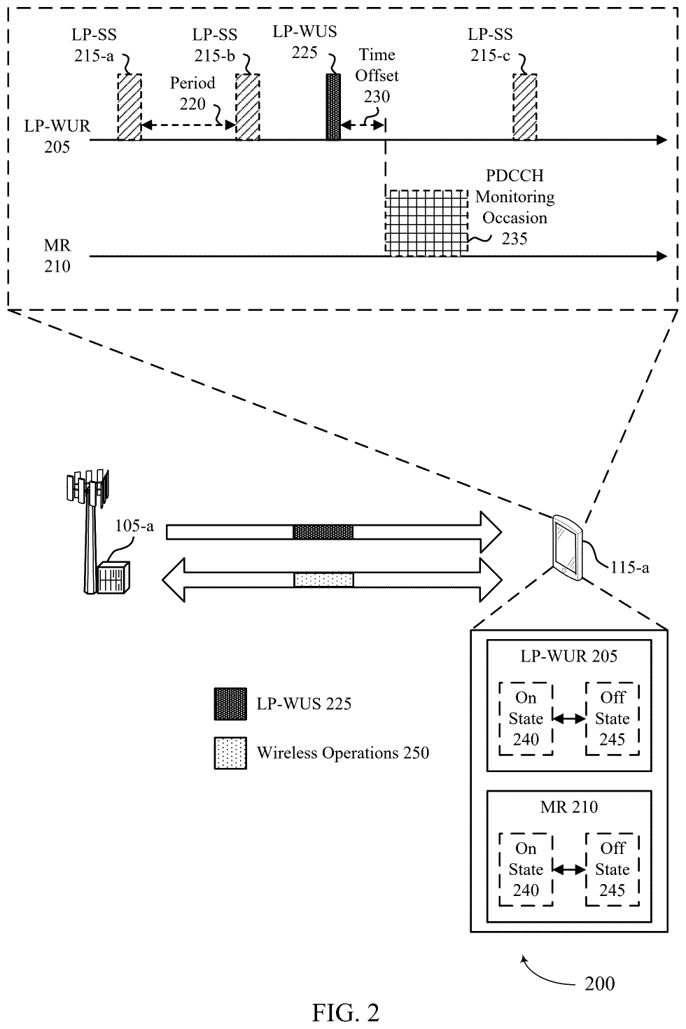

FIG. 2 shows an example of a wireless communications system 200 that supports LP-WUS for RRC connected mode in accordance with one or more aspects of the present disclosure. The wireless communications system 200 may implement or may be implemented by aspects of the wireless communications system 100. For example, the wireless communications system 200 may include a UE 115-a, which may be an example of a UE 115 as described herein. The wireless communications system 200 may include a network entity 105-a, which may be an example of a network entity 105 as described herein.

In some examples of wireless communications system 200, the UE 115-a and network entity 105-a may operate in accordance with one or more power saving procedures based on LP-WUS 225 and LP-SS 215 for RRC idle mode, RRC inactive mode, and RRC connected mode. In some examples, an LP-WUS based procedure may be advantageous over a discontinuous reception (DRX) mode. For instance, when operating in accordance with DRX operation, the UE 115-a may monitor for control information (e.g., via a PDCCH) from the network entity 105-a during a DRX active time of a given DRX cycle. Additionally, during a DRX inactive time of a given DRX cycle, the UE 115-a may refrain from monitoring for control information, and as such may save power by transitioning into sleep a state. In some cases, however, during the sleep state the UE 115-a may maintain activation of (e.g., power of) one or more components in accordance with the DRX mode. For example, the UE 115-a may periodically receive synchronization signals from the network entity 105-a to maintain time and frequency synchronization with the network. In some cases, the UE 115-a may receive such synchronization signals using an MR 210, where switching the MR 210 to an on state 240 may incur power. As such, the UE 115-a may determine to maintain the MR 210 in the on state 240 while operating in the DRX mode (e.g., even during a sleep state).

To further reduce power expenditure, the UE 115-a may operate in accordance with a second receiver (e.g., in addition to the MR 210). For example, the UE 115-a may include an LP-WUR 205 which may be a lower complexity radio or receiver compared to the MR 210. Such reductions in complexity of the LP-WUR 205 may allow for the UE 115-a to switch the LP-WUR 205 from the on state 240 to an off state 245 faster than the MR 210. Additionally, the UE may use the LP-WUR 205 to receive and process signals using less power compared to the MR 210.

In some examples, the UE 115-a may use the LP-WUR 205 and MR 210 in accordance with an LP-WUS based procedure. As part of the LP-WUS procedure, the UE 115-a may switch the MR 210 to the off state 245. Based on the MR 210 being in the off state 245, the UE 115-a may maintain synchronization with the network entity 105-a by periodically receiving LP-SSs 215 via the LP-WUR 205. For instance, as illustrated in FIG. 2, the UE 115-a may receive LP-SS 215-a, 215-b, and 215-c, where the periodicity between each LP-SS 215 may be based on period 220. In some examples, the periodicity associated the UE 115-a receiving the LP-SSs 215 may be less than the periodicity associated with the UE 115-a receiving synchronization signal blocks (SSBs) via the MR 210 (e.g., periodicity between LP-SSs 215 may be 320 ms and periodicity between SSBs may be 160 ms).

As part of the LP-WUS based procedure, the UE 115-a may monitor (e.g., via the LP-WUR 205) for an LP-WUS 225. As illustrated in FIG. 2, the UE 115-a may receive from the network entity 105-a the LP-WUS 225, where the LP-WUS 225 may indicate for the UE 115-a to switch the MR 210 from the off state 245 to the on state 240. For example, reception of the LP-WUS 225 may be indicative of the UE 115-a to monitor for control information using the MR 210 during a PDCCH monitoring occasion 235. In some examples, the PDCCH monitoring occasion 235 may occur a time offset 230 after the UE 115-a receives the LP-WUS 225, where the UE 115-a may transition the MR 210 to the on state 240 during the time offset 230. As such, the UE 115-a may monitor for and receive control information during the PDCCH monitoring occasion 235. In some examples, the UE 115-a may transition the MR 210 to the off state 245 after the PDCCH monitoring occasion in accordance with the LP-WUS based procedure to further reduce power expenditure at the UE 115-a.

As part of the LP-WUS based procedure, the UE 115-a may switch the LP-WUR 205 to the off state 245 (e.g., when the UE 115-a is not expected to receive LP-SS 215 or LP-WUS 225). For instance, the network entity 105-a transmit a control message (e.g., RRC, downlink control information (DCI), or MAC-control element (MAC-CE)) to the UE 115-a that configures one or more occasions for the UE 115-a to monitor for LP-SSs 215, to monitor for LP-WUSs 225, or both. As such, if the UE 115-a is not configured to monitor for LP-SS 215 or LP-WUS 225 for a configured duration, the UE 115-a may switch the LP-WUR 205 to the off state 245 to further reduce power expenditure at the UE 115-a.

Based on the LP-WUR 205 being a lower complexity radio or receiver compared to the MR 210, the UE 115-a may use the LP-WUR 205 to receive low complexity signals. For instance, the LP-WUR 205 may be capable of receiving OOK signals. Additionally, while the techniques described herein discuss the LP-WUR 205 receiving OOK signals, it is understood that the LP-WUR 205 may receive various types of low complexity signals including but not limited to binary phase shift keying (BPSK) signals, frequency shift keying (FSK) signals, and amplitude shift keying (ASK) signals. As such, LP-SSs 215 and LP-WUSs 225 may be examples of low complexity signals described herein.

In some cases, however, the low complexity nature of the LP-WUR 205 may reduce the reliability of wireless communications for one or more frequency ranges. For example, the FR2 range may be associated with beam pair management and maintenance communications between the UE 115-a and network entity 105-a. In some examples, the UE 115-a may handle such beam pair related communications via control messages. In some cases, however, such beam pair control messages may be associated with a signal structure that may be of a higher complexity than the LP-WUR 205 is capable of decoding. For instance, the beam pair control messages may be associated with an OFDM modulation format, which the MR 210 may be capable of decoding, but may increase power expenditure at the UE 115-a. As such, it may be advantageous for the network entity 105-a and UE 115-a to transmit control information via low complexity signals that the LP-WUR 205 may decode.

According to the techniques described herein, the UE 115-a and network entity 105-a may communicate control information via LP-WUSs 225 using a low complexity signal structure that the LP-WUR 205 may decode. For example, the network entity 105-a and the UE 115-a may configure an LP-WUS 225 to indicate a set of bits corresponding to control information using an OOK waveform, where the UE 115-a may use the LP-WUR 205 to receive the OOK waveform.

In some examples, the LP-WUS 225 may include one or more bits that indicates an identifier associated with the UE 115-a. For example, prior to reception of the LP-WUS 225, the UE 115-a may receive a control message from the network (e.g., RRC, DCI, or MAC-CE) that assigns the UE 115-a with an identifier. In some examples, the identifier may be specific to the UE 115-a. In some examples, the identifier may be UE 115-a group identifier associated with a set of UEs 115 that includes the UE 115-a. As such, the network entity 105-a may configure the identifier using either a unicast control message (e.g., in cases where the identifier is UE 115-a specific) or using groupcast or broadcast message (e.g., in cases where the identifier is a group UE identifier). In some examples, the UE 115-a may receive the control message assigning the identifier via the MR 210 or via the LP-WUR 205.

In some examples, the LP-WUS 225 may include a wake-up bit. For example, a first value of the wake-up bit may indicate for the UE 115-a to switch the MR 210 to the on state 240 to monitor for PDCCH from the network entity 105-a, and a second value of the wake-up bit may indicate for the UE 115-a to switch the MR 210 to the off state 245 and initiate an LP-WUS based procedure (e.g., go into a deep sleep state associated with the MR 210 being in the off state 245). Additionally, or alternatively, the network entity 105-a may configure the UE 115-a to monitor one or more LP-WUSs 225 while the UE 115-a is not in a deep sleep state. That is, the UE 115-a may monitor for an LP-WUS 225 via the MR 210, where the LP-WUS 225 indicates for the UE 115-a to start an LP-WUS based procedure (e.g., transition the MR 210 to the off state 245 and receive subsequent LP-WUSs 225 via the LP-WUR 205). Additionally, while the techniques herein indicate that the wake-up bit is a singular bit, it is understood that multiple bits of the LP-WUS 225 may be used to indicate the information discussed with reference to the wake-up bit.

In some examples, the LP-WUS 225 may include one or more CSI report bits. For example, a first bit of the one or more CSI report bits may indicate for the UE 115-a to transmit a CSI report to the network entity 105-a. Additionally, or alternatively, the one or more CSI reports bits may include one or more second bits that may indicate one or more time and frequency resources for the UE 115-a to transmit the CSI report over.

In some examples, the LP-WUS 225 may include one or more beam switch bits. For example, a first bit of the one or more beam switch bits may indicate for the UE 115-a to switch from a first beam (e.g., or first beam pair) for wireless communications with the network entity 105-a to a second beam (e.g., or second beam pair). Additionally, or alternatively, the one or more beam switch bits may include a one or more second bits that indicate which beam the UE 115-a may switch to. That is the one or more second bits may explicitly indicate the second beam for switching. In some examples, the UE 115-a may be configured with a set of beams, where each value of the one or more second bits may be associated with a respective beam of the set of beams.

In some examples, the UE 115-a may be configured with one or more transmission configuration indication (TCI) states, where the one or more configured TCI states may configure a quasi co-location (QCL) relationship between one or two downlink reference signals (e.g., received by MR 210) and a signal or a channel. The one or two downlink reference signals may be SSB, CSI-RS, or a combination thereof. The QCL relationship may be configured by a higher layer parameter (e.g., qcl-Type1 for the first downlink reference signal and qcl-Type2 for the second downlink reference signal, if configured). The QCL types corresponding to each downlink reference signal may include (e.g., take) one of the following values: QCL-TypeA (e.g., Doppler shift), QCL-TypeB (e.g., Doppler spread), QCL-TypeC (e.g., average delay), and QCL-TypeD (e.g., spatial reception parameter). In examples where a TCI state is activated, the UE 115-a may assume that the signal or the channel for which the TCI state is activated may experience the same channel conditions as the one or two downlink reference signals indicated in the TCI state. If a TCI state that indicates QCL-TypeD relation with SSB is activated for the LP-WUS 225, then the UE 115-a may use a spatial reception filter (e.g., reception beam) used to receive the SSB to receive the LP-WUS 225. The LP-WUS 225 may include one or more TCI state activation or deactivation bits for activating or deactivating the one or more TCI states for LP-WUS 225. Additionally, or alternatively, the UE 115-a may activate or deactivate one or more TCI states for receiving the LP-WUS 225 based on MAC-CE or DCI signaling from the network entity 105-a.

In some examples, the LP-WUS 225 may include one or more synchronization signal transmission bits. For example, a first bit of the one or more synchronization signal transmission bits may indicate to the UE 115-a that a synchronization signal is to be transmitted by the network entity 105-a to the UE 115-a for time and frequency synchronization. Additionally, or alternatively, the one or more synchronization signal transmission bits may include one or more second bits that may indicate one or more time and frequency resources for the UE 115-a to receive the indicate synchronization signal over.

In some examples, the LP-WUS 225 may include one or more sounding reference signal (SRS) transmission bits. For example, a first bit of the one or more SRS transmission bits may indicate for the UE 115-a to transmit an SRS to the network entity 105-a. Additionally, or alternatively, the SRS transmission bits may include one or more second bits that may indicate one or more time and frequency resources for the UE 115-a to transmit the SRS over.

In some examples, the LP-WUS 225 may include one or more PDCCH order bits. For example, a first bit of the one or more PDCCH order bits may indicate for the UE 115-a to transmit a physical random access channel (PRACH) message to the network entity 105-a. Additionally, or alternatively, the one or more PDCCH order bits may include one or more second bits that may indicate one or more time and frequency resources for the UE 115-a to transmit the PRACH message over. In some examples, the PRACH message may include information associated with uplink timing synchronization between the network entity 105-a and the UE 115-a.

Based on receiving the LP-WUS 225 that includes the control information, the UE 115-a switch the MR 210 to the on state 240. As such, the UE 115-a may perform one or more wireless operations 250 using the MR 210 in accordance with the control information included in the LP-WUS 225. For example, if the LP-WUS 225 includes the wake-up bit, the UE 115-a may operate in accordance with the bit value indicated by the wake-up bit. Additionally, or alternatively, if the LP-WUS 225 includes the one or more CSI report bits, the UE 115-a may transmit a CSI report via the MR 210 to the network entity 105-a (e.g., during the time and frequency resources indicted by the second one or more bits, if included). Additionally, or alternatively, if the LP-WUS 225 includes the one or more beam switch bits, the UE 115-a may switch from a first beam to a second beam for wireless communications with the network entity 105-a. Additionally, or alternatively, if the LP-WUS 225 includes the one or more TCI state activation/deactivation bits, the UE 115-a may activate or deactivate one or more TCI states associated with LP-WUS. Additionally, or alternatively, if the LP-WUS 225 includes the one or more synchronization signal transmission bits, the UE 115-a may monitor and receive via the MR 210 a synchronization signal from the network entity 105-a (e.g., during the time and frequency resources indicted by the second one or more bits, if included). Additionally, or alternatively, if the LP-WUS 225 includes the one or more SRS transmission bits, the UE 115-a may transmit via the MR 210 an SRS to the network entity 105-a (e.g., during the time and frequency resources indicted by the second one or more bits, If included). Additionally, or alternatively, if the LP-WUS 225 includes the one or more PDCCH order bits, the UE 115-a may transmit a PRACH message to the UE 115-a (e.g., during the time and frequency resources indicted by the second one or more bits, if included). As such, the UE 115-a will perform the one or more wireless operations 250 indicated by the LP-WUS 225 (e.g., after transitioning the MR 210 to the on state 240).

In some examples, the UE 115-a may restart or resume the LP-WUS based procedure after performing the one or more wireless operations 250 in accordance with the MR 210 being in the on state 240. For example, the UE 115-a may transition the MR 210 back to the off state 245 after completion of the one or more wireless operations 250. In some examples, the UE 115-a may transition the MR 210 to the off state 245 directly after completing the one or more wireless operations 250. In some examples, the UE 115-a may transition the MR 210 to the off state 245 a duration after completing the one or more wireless operations 250. In some examples, said duration may be configured by the network entity 105-a (e.g., via RRC, DCI, or MAC-CE) or may be preconfigured at the UE 115-a.

In some examples, the network entity 105-a may transmit one or more information bits associated with the LP-WUS 225. For example, the network entity 105-a may transmit to the UE 115-a the one or more information bits (e.g., in any combination of M-quantity of bits) that indicates the type of waveform used for the LP-WUS 225 (e.g., OOK waveform), a spreading sequence of the LP-WUS 225, one or more time and frequency resources of the LP-WUS 225, or a combination thereof. In some examples, the UE 115-a may be configured to receive LP-WUS 225 in an active downlink bandwidth part (BWP) of the serving cell of the UE 115-a. Additionally, or alternatively, the UE 115-a may be configured to receive LP-WUS 225 outside the active downlink BWP (e.g., in the default downlink BWP of the serving cell). In some examples, the one or more information bits may be included prior to the UE identifier and the control information bits in the LP-WUS 225. In some examples, the one or more information bits may be indicated by the network entity 105-a in a control message prior to the LP-WUS 225 (e.g., via RRC, DCI, or MAC-CE).

By including control information in the LP-WUS 225, the UE 115-a may reduce power expenditure of the MR 210. For instance, since the LP-WUR 205 may receive the LP-WUS 225 that includes the control information, the UE 115-a may increase the duration in which the MR 210 is in the off state 245. As such, the UE 115-a may reduce power expenditure of the MR 210, which may increase battery life and battery longevity of the UE 115-a.

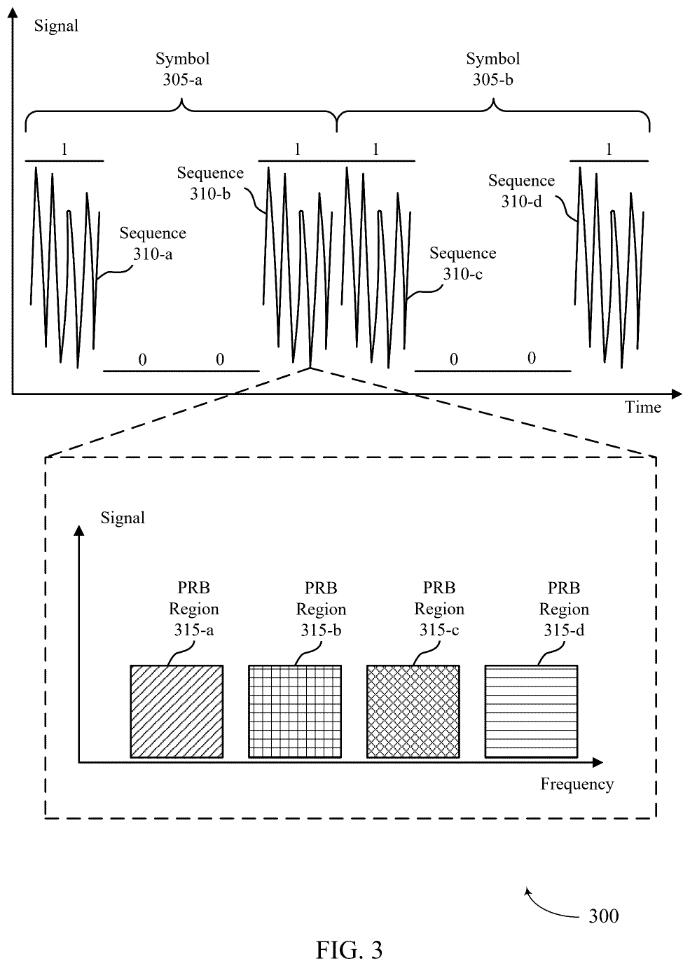

FIG. 3 shows an example of a LP-WUS transmission 300 that supports LP-WUS for RRC connected mode in accordance with one or more aspects of the present disclosure. The LP-WUS transmission 300 may implement or may be implemented by aspects of the wireless communications system 100 and 200. For example, the LP-WUS transmission 300 may be an example of an LP-WUS 225 that indicates one or more bits of control information, as described with reference to FIG. 2. Additionally, the LP-WUS transmission 300 may be an example of a wireless transmission from a network entity 105 to a UE 115, as described herein.

In some examples, LP-WUS transmission 300 may be an example of a low complexity waveform. For example, as illustrated in FIG. 3, the network entity 105 may transmit the LP-WUS transmission 300 via an OOK waveform. While the example provided in FIG. 3 is with reference to OOK signaling, it is understood that the network entity 105 and the UE 115 may communicate the LP-WUS transmission 300 via other types of low complexity signaling (e.g., BPSK, FSK, ASK, among other examples).

In some examples, the LP-WUS transmission 300 may support different types of OOK waveforms (e.g., OOK-1 and OOK-4). In OOK-1 modulation, each symbol 305 represents a single bit of information. The presence of the carrier signal represents a first binary state (e.g., ‘1’), while the absence of the carrier signal represents a second binary state (e.g., ‘0’). As such, M-quantity of bits may be carried using M-quantity of symbols 305. Additionally, or alternatively, OOK-1 modulation may be associated with an overlaid OFDM sequence, where the network entity 105 transmits the LP-WUS concurrently with other signals in subcarriers not used for transmission of the LP-WUS. In some examples, OOK-1 may be the lowest complexity type of OOK modulation and may be used in applications where simplicity and low-complexity hardware are prioritized over high data rates.

In OOK-4 modulation, each symbol 305 represents four bits of information. That is, rather than in OOK-1 where each symbol 305 indicates a single binary state, each symbol 305 may represent a four-bit sequence. As such, OOK-4 modulation may allow for higher data rates compared to OOK-1 while still retaining the low complexity signal structure associated with OOK modulation. In some examples, OOK-4 modulation may be used when slightly higher data rates are applicable, but the simplicity of OOK modulation is still desirable.

As illustrated in FIG. 3, the LP-WUS transmission 300 may be associated with an OOK-4 modulation. Additionally, a given LP-WUS transmission 300 may be associated with a set of transmission parameters. For instance, a value M may be associated with the quantity of bits expressed per symbol 305, a value N may be the quantity of subcarriers explicitly allocated to the LP-WUS transmission 300, and a value K may be the total quantity of subcarriers allocated during the transmission of the LP-WUS transmission 300. In the example of LP-WUS transmission 300, the value of M is equal to four bits, N is equal to 288 subcarriers (e.g., 12 resource blocks), and K is equal to 1024 subcarriers. Additionally, for the example of LP-WUS transmission 300 the subcarrier spacing (SCS) may be set equal to 15 kilohertz (kHz) and the LP-WUS transmission 300 may span two symbols 305 (e.g., two OFDM symbols).

Based on the example set of transmission parameters, each symbol 305 may indicate four bits of information (e.g., in accordance with OOK-4). For instance, symbol 305-a may indicate four respective bits (e.g., ‘1001’) and symbol 305-b may indicate four respective bits (e.g., ‘1001’). As such, in the example of FIG. 3, symbol 305-a and 305-b may indicate a total of eight bits.

Additionally, or alternatively, the network entity 105 may use a respective orthogonal spreading sequence from a set of configured spreading sequences to modulate LP-WUS subcarriers. For example, sequences 310 in each of the “on” durations of the LP-WUS transmission 300 may be associated with a same sequence 310. That is, each of sequence 310-a, 310-b, 310-c, and 310-d may be a same sequence 310 from a configured set of spreading sequences. As such, each respective sequence 310 of the configured set of spreading sequences may be associated with a respective set of bits. For example, if there are four different sequences 310 configured in the set of spreading sequences, then each of the four different sequences 310 may indicate two bits (e.g., a first sequence 310 indicates bit value ‘00’, a second sequence 310 indicates bit value ‘01’, a third sequence 310 indicates bit value ‘10’, and a fourth sequence 310 indicates bit value ‘11’). As such, the sequence 310 that the network entity 105 selects for the LP-WUS transmission 300 may indicate an additional two bits.

In some examples, the sequence 310-a, 310-b, 310-c, and 310-d may be different sequences 310 from a configured set of spreading sequences 310. For example, each sequence 310 in the configured set of spreading sequences 310 may correspond to a sequence of one or more bits. That is, there may be two spreading sequences 310 in the configured set of spreading sequences 310, where a first sequence represents ‘1’ and a second sequence represents ‘0’. As such, of the sequences 310-a, 310-b, 310-c, and 310-d may be one of the two sequences in the configured set, and together, may form a sequence of four bits (e.g., or any other quantity of bits). Additionally, while the example of FIG. 3 describes the use of four different configured spreading sequences, it is understood that the network entity 105 and UE 115 may be configured with any quantity of spreading sequences that indicate any quantity of bits. For instance, if eight different spreading sequences are configured, then each of the eight different spreading sequences may be associated with a respective string of three bits. Examples of different types of sequences 310 used may include but are not limited to a Zadoff-Chu sequence, an M-sequence, a Gold sequence, and a pseudo-random sequence.

Additionally, in the example of FIG. 3, the network entity 105 transmits a given sequence 310 during the “on” duration. In some other examples, however, the network entity 105 may transmit a given sequence 310 during an “off” duration (e.g., using Manchester coding). For instance, Manchester coding is a form of line coding in which each bit of data is represented by a transition in the middle of a bit period. In Manchester coding, a first logical value (e.g., ‘1’) may be represented by a high-to-low transition, while a second logical value (e.g., ‘0’) may be represented by a low-to-high transition. In some examples of Manchester coding, the transition occurs at the midpoint of the bit period. Using Manchester coding, the network entity 105 may transmit a spreading sequence 310 of the configured set of spreading sequences 310 in each “high” portion of the high-to-low or low-to-high transition.

Additionally, or alternatively, the network entity 105 may use a respective physical resource block (PRB) region 315 from a set of configured PRB regions 315 for transmission of the LP-WUS. In the example of FIG. 3, the carrier bandwidth associated with the LP-WUS transmission may be equal to the product of the value N and the SCS (e.g., 288×15 kHz=4.32 MHz). In an example where the configured bandwidth spans 20 MHz, then the network entity 105 may configure four different PRB regions 315 that may be used to transmit the LP-WUS. For example, the network entity 105 may perform LP-WUS transmission 300 using PRB region 315-a, 315-b, 315-c, or 315-d. As such, each respective PRB region 315 may indicate an additional two bits (e.g., PRB region 315-a may indicate bit value ‘00’, PRB region 315-b may indicate bit value ‘01’, PRB region 315-c may indicate bit value ‘10’, and PRB region 315-d may indicate bit value ‘11’). Additionally, while the example of FIG. 3 describes the use of four different PRB regions 315, it is understood that the network entity 105 may configure any quantity of PRB regions 315 that indicate any quantity of bits. For instance, if the eight different PRB regions 315 are configured, then each of the eight different PRB regions 315 may be associated with a respective string of three bits.

The example described with reference to FIG. 3 may allow a network entity 105 to transmit 12 bits of information as part of the LP-WUS transmission 300 using a low complexity waveform. In some examples, the bits of information included in the LP-WUS transmission 300 may indicate one or more of the UE identifier and the control information described with reference to FIG. 2. As such, the UE 115 may use an LP-WUR (e.g., LP-WUR 205, with reference to FIG. 2) to receive control information from the network entity 105 via the LP-WUS transmission 300.

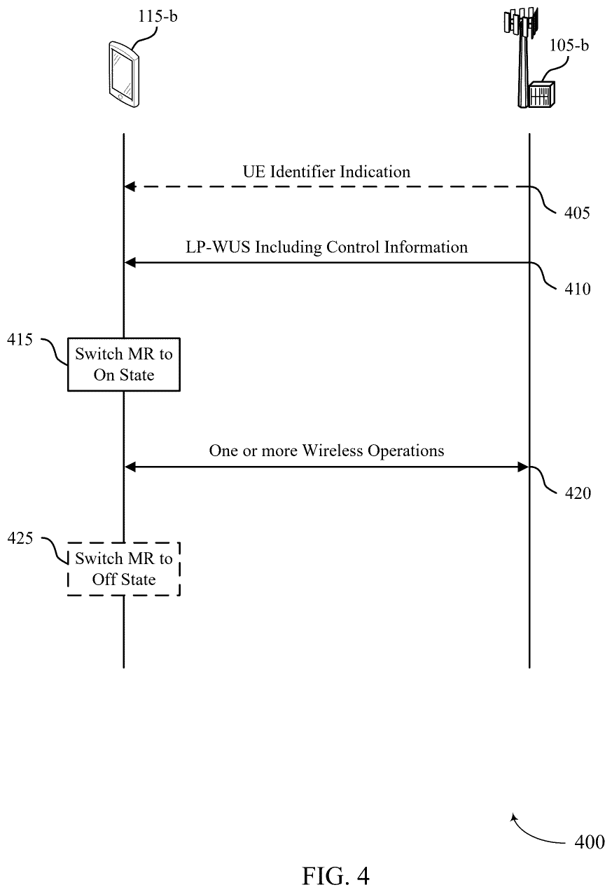

FIG. 4 shows an example of a process flow 400 that supports LP-WUS for RRC connected mode in accordance with one or more aspects of the present disclosure. In some examples, process flow 400 may implement aspects of wireless communications system 100, wireless communications system 200, and LP-WUS transmission 300. Process flow 400 may include a UE 115-b and a network entity 105-b, as described with reference to FIGS. 1 through 3. Alternative examples of the following may be implemented, where some steps are performed in a different order than described or are not performed at all. In some cases, steps may include additional features not mentioned below, or further steps may be added. In addition, it is understood that these processes may occur between any quantity of network devices and network device types.

At 405, the UE 115-b may receive, prior to receiving the LP-WUS, a control message that assigns an identifier to the UE 115-b. In some examples, the identifier may be exclusively assigned to the UE 115-b or assigned to a set of UEs 115.

At 410, the UE 115-b may receive, via an LP-WUR (e.g., the LP-WUR 205, with reference to FIG. 2), an LP-WUS. In some examples, the LP-WUS may be indicative that the UE 115-b is to switch from use of the LP-WUR to an MR (e.g., the MR 210, with reference to FIG. 2), where the LP-WUS may also include control information. In some examples, the LP-WUR is limited with respect to the MR. For instance, the LP-WUR may be of a lower complexity and capable of receiving and decoding less complex symbols compared to the MR. In some examples, the control information in the LP-WUS further indicates the identifier (e.g., assigned to the UE 115-b, at 405).

In some examples, the UE 115-b may receive the control information as one or more information bits associated with one or more parameters of the LP-WUS. For example, the one or more parameters may include an OOK waveform, a spreading sequence for portions of the OOK waveform, a distribution of one or more time resources associated with the portions of the OOK waveform, a distribution of one or more frequency resources associated with the portions of the OOK waveform, or a combination thereof.

Additionally, or alternatively, the UE 115-b may receive a configuration message that indicates for the UE 115-b to monitor for one or more LP-WUSs using the MR.

At 415, the UE 115-b may switch the MR to an on state based on receiving the LP-WUS, via the LP-WUR.

At 420, the UE 115-b may perform, after switching the MR to the on state, one or more operations associated with the control information indicated in the LP-WUS.

In some examples, the control information indicated in the LP-WUS may include a wake-up bit that has one of a first value or a second value, where the first value of the wake-up bit indicates for the UE 115-b to switch the MR to the on state and the second value of the wake-up bit indicates for the UE 115-b to switch the MR to an off state. As such, if the wake-up bit is of the first value the UE 115-b may switch the MR to the on state, and if the wake-up bit is of a second value the UE 115-b may switch the MR to an off state (e.g., in accordance with a LP-WUS based procedure).

Additionally, or alternatively, the control information indicated in the LP-WUS may include one or more CSI bits. As such, the UE 115-b may transmit, as part of the one or more operations, a CSI report based on the control information indicated in the LP-WUS including the one or more CSI bits. In some examples, the one or more CSI bits may further indicate one or more time resources and one or more frequency resources for transmission of the CSI report.

Additionally, or alternatively, the control information indicated in the LP-WUS may include one or more beam switch bits. As such, the UE 115-b may switch, as part of the one or more operations, from a first beam associated with communications with a network entity 105-b to a second beam associated with communications with the network entity 105-b. In some examples, the one or more beam switch bits may further indicate the second beam.

Additionally, or alternatively, the control information indicated in the LP-WUS may include one or more TCI state activation/deactivation bits for activating or deactivating the one or more TCI states associated with LP-WUS. As such, the UE 115-b may activate or deactivate, as part of the one or more operations, one or more TCI states for receiving LP-WUS.

Additionally, or alternatively, the control information indicated in the LP-WUS may include a synchronization signal transmission bit that indicates a synchronization signal to be transmitted by the network entity 105-b. As such, the UE 115-b may receive, as part of the one or more operations, the synchronization signal from the network entity 105-b.

Additionally, or alternatively, the control information indicated in the LP-WUS may include an SRS bit that indicates for the UE 115-b to transmit an SRS. As such, the UE 115-b may transmit, as part of the one or more operations, the SRS based on the control information indicated in the LP-WUS including the SRS bit.

Additionally, or alternatively, the control information indicated in the LP-WUS may include a PDCCH order bit that indicates for the UE 115-b to transmit a PRACH message to the network entity 105-b. As such, the UE 115-b may transmit, as part of the one or more operations, the PRACH message to the network entity 105-b based on the control information indicated in the LP-WUS including the PDCCH order bit. In some examples, the PRACH message may include uplink timing synchronization information.

At 425, the UE 115-b may switch, after performing the one or more operations, the MR to an off state in accordance with an LP-WUS based procedure. In some examples, the UE 115-b may switch the MR to the off state directly after performing the one or more operations in accordance with the LP-WUS based procedure. In some other examples, the UE 115-b may switch the MR to the off state after a configured duration in accordance with the LP-WUS based procedure.

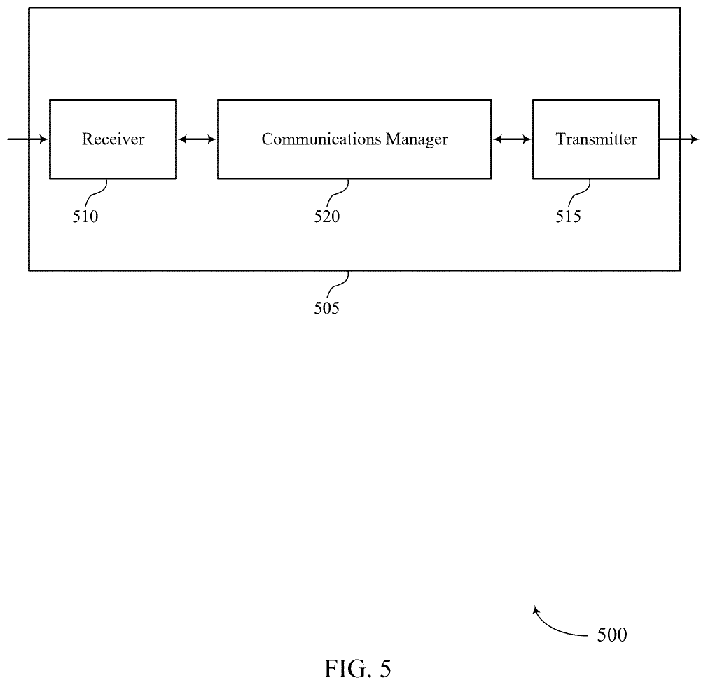

FIG. 5 shows a block diagram 500 of a device 505 that supports LP-WUS for RRC connected mode in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to LP-WUS for RRC connected mode). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to LP-WUS for RRC connected mode). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of LP-WUS for RRC connected mode as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving, via a first radio, a LP-WUS (LP-WUS) that is indicative that the UE is to switch from use of the first radio to a second radio, where the LP-WUS also includes control information, and where the first radio is limited with respect to the second radio. The communications manager 520 is capable of, configured to, or operable to support a means for switching the second radio to an on state based on receiving, via the first radio, the LP-WUS. The communications manager 520 is capable of, configured to, or operable to support a means for performing, after switching the second radio to the on state, one or more operations associated with the control information indicated in the LP-WUS.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced processing, reduced power consumption, and more efficient utilization of communication resources.

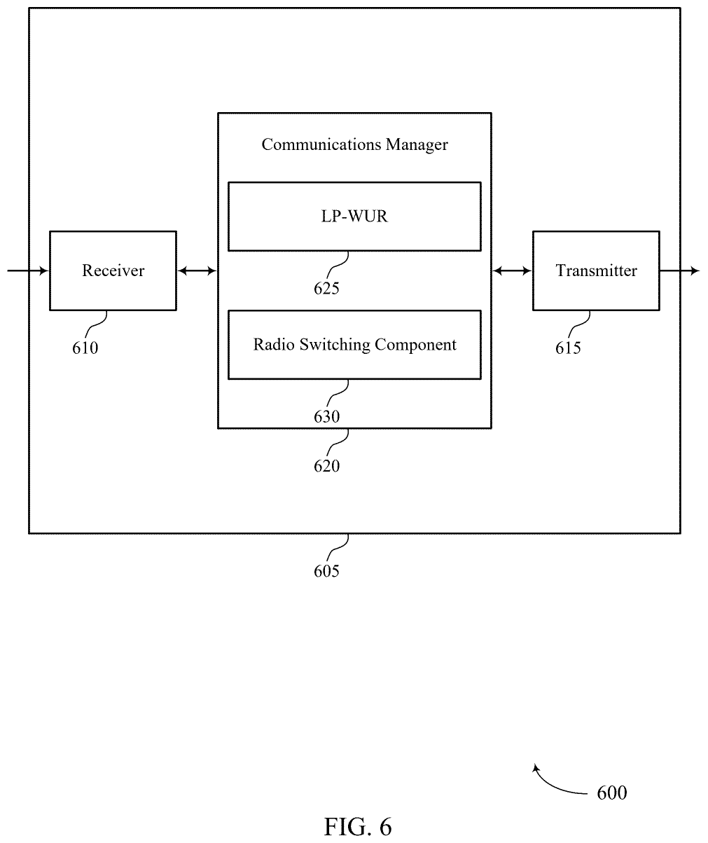

FIG. 6 shows a block diagram 600 of a device 605 that supports LP-WUS for RRC connected mode in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to LP-WUS for RRC connected mode). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to LP-WUS for RRC connected mode). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of LP-WUS for RRC connected mode as described herein. For example, the communications manager 620 may include an LP-WUR 625 a radio switching component 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The LP-WUR 625 is capable of, configured to, or operable to support a means for receiving, via a first radio, a LP-WUS (LP-WUS) that is indicative that the UE is to switch from use of the first radio to a second radio, where the LP-WUS also includes control information, and where the first radio is limited with respect to the second radio. The radio switching component 630 is capable of, configured to, or operable to support a means for switching the second radio to an on state based on receiving, via the first radio, the LP-WUS. The LP-WUR 625 is capable of, configured to, or operable to support a means for performing, after switching the second radio to the on state, one or more operations associated with the control information indicated in the LP-WUS.

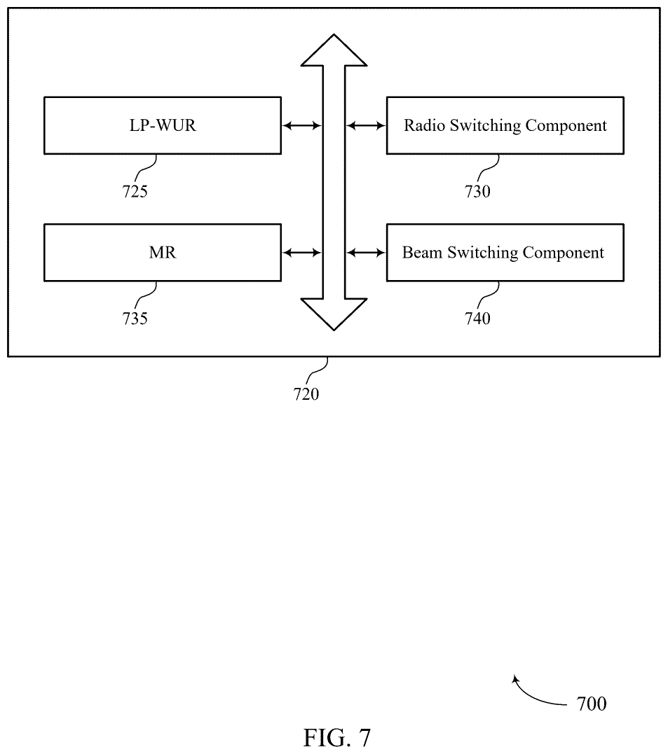

FIG. 7 shows a block diagram 700 of a communications manager 720 that supports LP-WUS for RRC connected mode in accordance with one or more aspects of the present disclosure. The communications manager 720 may be an example of aspects of a communications manager 520, a communications manager 620, or both, as described herein. The communications manager 720, or various components thereof, may be an example of means for performing various aspects of LP-WUS for RRC connected mode as described herein. For example, the communications manager 720 may include an LP-WUR 725, a radio switching component 730, an MR 735, a beam switching component 740, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The LP-WUR 725 is capable of, configured to, or operable to support a means for receiving, via a first radio, a LP-WUS (LP-WUS) that is indicative that the UE is to switch from use of the first radio to a second radio, where the LP-WUS also includes control information, and where the first radio is limited with respect to the second radio. The radio switching component 730 is capable of, configured to, or operable to support a means for switching the second radio to an on state based on receiving, via the first radio, the LP-WUS. In some examples, the LP-WUR 725 is capable of, configured to, or operable to support a means for performing, after switching the second radio to the on state, one or more operations associated with the control information indicated in the LP-WUS.

In some examples, the MR 735 is capable of, configured to, or operable to support a means for receiving, prior to receiving the LP-WUS, a control message that assigns an identifier to the UE, where the control information in the LP-WUS further indicates the identifier.

In some examples, the identifier is exclusively assigned to the UE or to a set of UEs.

In some examples, the control information indicated in the LP-WUS includes a wake-up bit that has one of a first value or a second value. In some examples, the first value of the wake-up bit indicates for the UE to switch the second radio to the on state. In some examples, the second value of the wake-up bit indicates for the UE to switch the second radio to an off state.

In some examples, the MR 735 is capable of, configured to, or operable to support a means for receiving a configuration message that indicates for the UE to monitor for one or more LP-WUSs using the second radio.

In some examples, the control information indicated in the LP-WUS includes one or more CSI bits, and the MR 735 is capable of, configured to, or operable to support a means for transmitting, as part of the one or more operations, a CSI report based on the control information indicated in the LP-WUS including the one or more CSI bits.

In some examples, the one or more CSI bits further indicate one or more time resources and one or more frequency resources for transmission of the CSI report.

In some examples, the control information indicated in the LP-WUS includes one or more beam switch bits, and the beam switching component 740 is capable of, configured to, or operable to support a means for switching, as part of the one or more operations, from a first beam associated with communications with a network entity to a second beam associated with communications with the network entity.

In some examples, the one or more beam switch bits further indicate the second beam.

In some examples, the control information indicated in the LP-WUS includes one or more TCI state activation or deactivation bits for activating or deactivating the one or more TCI states associated with LP-WUS.

In some examples, the control information indicated in the LP-WUS includes a synchronization signal transmission bit that indicates a synchronization signal to be transmitted by a network entity, and the MR 735 is capable of, configured to, or operable to support a means for receiving, as part of the one or more operations, the synchronization signal from the network entity.

In some examples, the control information indicated in the LP-WUS includes a sounding reference signal bit that indicates for the UE to transmit a sounding reference signal, and the MR 735 is capable of, configured to, or operable to support a means for transmitting, as part of the one or more operations, the sounding reference signal based on the control information indicated in the LP-WUS including the sounding reference signal bit.

In some examples, the control information indicated in the LP-WUS includes a physical downlink control channel order bit that indicates for the UE to transmit a physical random access channel message to a network entity, and the MR 735 is capable of, configured to, or operable to support a means for transmitting, as part of the one or more operations, the physical random access channel message to the network entity based on the control information indicated in the LP-WUS including the physical downlink control channel order bit.

In some examples, the physical random access channel message includes uplink timing synchronization information.

In some examples, the radio switching component 730 is capable of, configured to, or operable to support a means for switching, after performing the one or more operations, the second radio to an off state in accordance with an LP-WUS procedure.

In some examples, the UE switches the second radio to the off state after a configured duration in accordance with the LP-WUS procedure.

In some examples, the LP-WUR 725 is capable of, configured to, or operable to support a means for receiving the control information as one or more information bits associated with one or more parameters of the LP-WUS, the one or more parameters including an on-off keying waveform, a spreading sequence for portions of the on-off keying waveform, a distribution of one or more time resources associated with the portions of the on-off keying waveform, a distribution of one or more frequency resources associated with the portions of the on-off keying waveform, or a combination thereof.

In some examples, the first radio is a LP-WUR and the second radio is a MR.

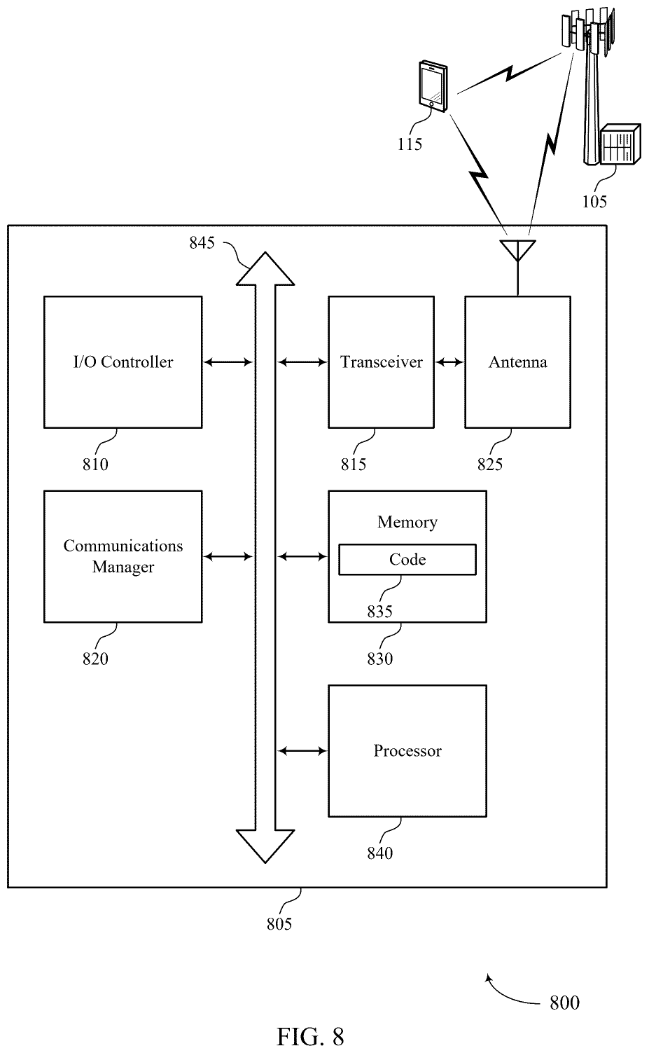

FIG. 8 shows a diagram of a system 800 including a device 805 that supports LP-WUS for RRC connected mode in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting LP-WUS for RRC connected mode). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving, via a first radio, a LP-WUS (LP-WUS) that is indicative that the UE is to switch from use of the first radio to a second radio, where the LP-WUS also includes control information, and where the first radio is limited with respect to the second radio. The communications manager 820 is capable of, configured to, or operable to support a means for switching the second radio to an on state based on receiving, via the first radio, the LP-WUS. The communications manager 820 is capable of, configured to, or operable to support a means for performing, after switching the second radio to the on state, one or more operations associated with the control information indicated in the LP-WUS.

By including or configuring the communications manager 820 in accordance with examples as described herein, the device 805 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of LP-WUS for RRC connected mode as described herein, or the at least one processor 840 and the at least one memory 830 may be otherwise configured to, individually or collectively, perform or support such operations.

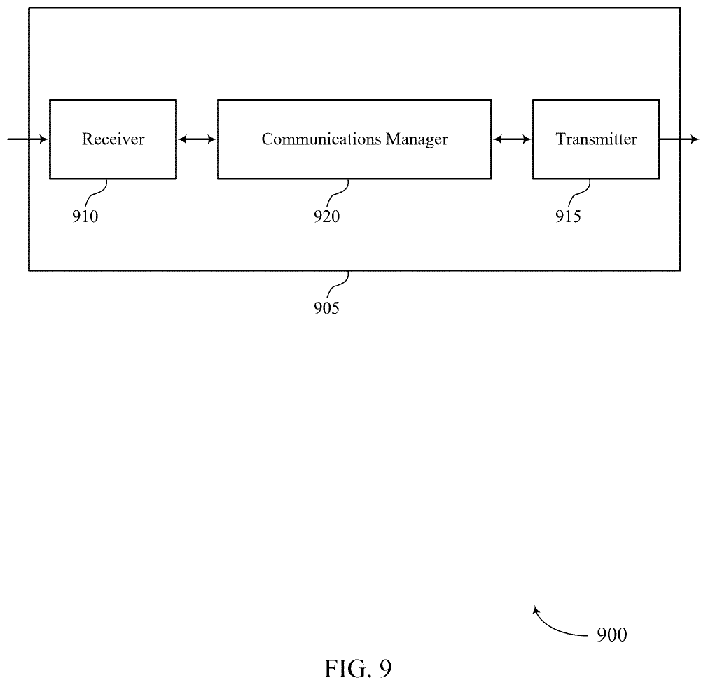

FIG. 9 shows a block diagram 900 of a device 905 that supports LP-WUS for RRC connected mode in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of LP-WUS for RRC connected mode as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for transmitting a configuration message that indicates for a UE to monitor for one or more LP-WUSs (LP-WUSs). The communications manager 920 is capable of, configured to, or operable to support a means for transmitting a LP-WUS that is indicative that the UE is to switch from use of a first radio to a second radio, where the LP-WUS also includes control information, and where the first radio is limited with respect to the second radio.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced processing, reduced power consumption, and more efficient utilization of communication resources.

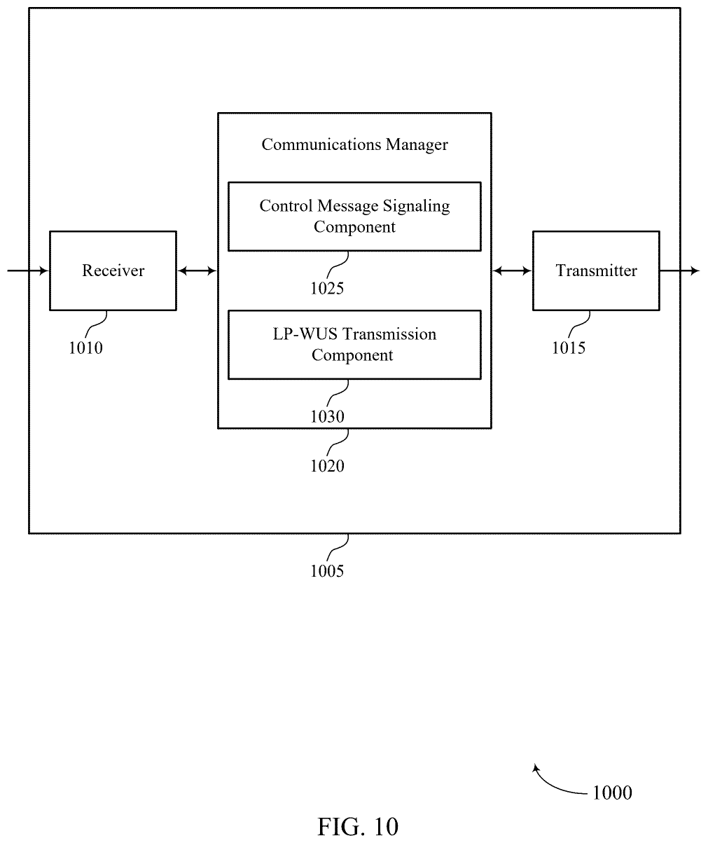

FIG. 10 shows a block diagram 1000 of a device 1005 that supports LP-WUS for RRC connected mode in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of LP-WUS for RRC connected mode as described herein. For example, the communications manager 1020 may include a control message signaling component 1025 an LP-WUS transmission component 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The control message signaling component 1025 is capable of, configured to, or operable to support a means for transmitting a configuration message that indicates for a UE to monitor for one or more LP-WUSs (LP-WUSs). The LP-WUS transmission component 1030 is capable of, configured to, or operable to support a means for transmitting a LP-WUS that is indicative that the UE is to switch from use of a first radio to a second radio, where the LP-WUS also includes control information, and where the first radio is limited with respect to the second radio.

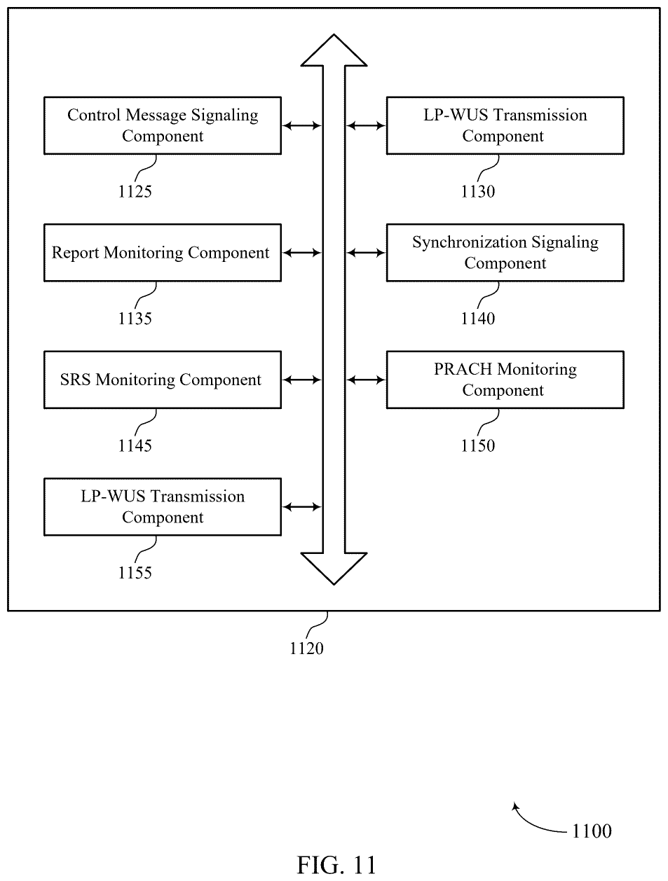

FIG. 11 shows a block diagram 1100 of a communications manager 1120 that supports LP-WUS for RRC connected mode in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of LP-WUS for RRC connected mode as described herein. For example, the communications manager 1120 may include a control message signaling component 1125, an LP-WUS transmission component 1130, a report monitoring component 1135, a synchronization signaling component 1140, an SRS monitoring component 1145, a PRACH monitoring component 1150, an LP-WUS transmission component 1155, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The control message signaling component 1125 is capable of, configured to, or operable to support a means for transmitting a configuration message that indicates for a UE to monitor for one or more LP-WUSs (LP-WUSs). The LP-WUS transmission component 1130 is capable of, configured to, or operable to support a means for transmitting a LP-WUS that is indicative that the UE is to switch from use of a first radio to a second radio, where the LP-WUS also includes control information, and where the first radio is limited with respect to the second radio.

In some examples, the control message signaling component 1125 is capable of, configured to, or operable to support a means for transmitting, prior to transmitting the LP-WUS, a control message that assigns an identifier to the UE, where the control information in the LP-WUS further indicates the identifier.

In some examples, the identifier is exclusively assigned to the UE or to a set of UEs.

In some examples, the control information indicated in the LP-WUS includes a wake-up bit that has one of a first value or a second value. In some examples, the first value of the wake-up bit indicates for the UE to switch the second radio to an on state. In some examples, the second value of the wake-up bit indicates for the UE to switch the second radio to an off state.

In some examples, the control information indicated in the LP-WUS includes one or more CSI bits, and the report monitoring component 1135 is capable of, configured to, or operable to support a means for receiving a CSI report based on the control information indicated in the LP-WUS including the one or more CSI bits.

In some examples, the one or more CSI bits further indicate one or more time resources and one or more frequency resources for transmission at the UE of the CSI report.

In some examples, the control information indicated in the LP-WUS includes one or more beam switch bits that indicates for the UE to switch from a first beam associated with communications with a network entity to a second beam associated with communications with the network entity.

In some examples, the one or more beam switch bits further indicate the second beam.

In some examples, the control information indicated in the LP-WUS includes a synchronization signal transmission bit that indicates a synchronization signal to be transmitted by a network entity, and the synchronization signaling component 1140 is capable of, configured to, or operable to support a means for transmitting, to the UE, the synchronization signal.

In some examples, the control information indicated in the LP-WUS includes a sounding reference signal bit that indicates for the UE to transmit a sounding reference signal, and the SRS monitoring component 1145 is capable of, configured to, or operable to support a means for receiving the sounding reference signal based on the control information indicated in the LP-WUS including the sounding reference signal bit.

In some examples, the control information indicated in the LP-WUS includes a physical downlink control channel order bit that indicates for the UE to transmit a physical random access channel message to the network entity, and the PRACH monitoring component 1150 is capable of, configured to, or operable to support a means for receiving, from the UE, the physical random access channel message based on the control information indicated in the LP-WUS including the physical downlink control channel order bit.

In some examples, the physical random access channel message includes uplink timing synchronization information.

In some examples, the LP-WUS transmission component 1155 is capable of, configured to, or operable to support a means for transmitting the control information as one or more information bits associated with one or more parameters of the LP-WUS, the one or more parameters including an on-off keying waveform, a spreading sequence for portions of the on-off keying waveform, a distribution of one or more time resources associated with the portions of the on-off keying waveform, a distribution of one or more frequency resources associated with the portions of the on-off keying waveform, or a combination thereof.

In some examples, the first radio is a LP-WUR and the second radio is a MR.

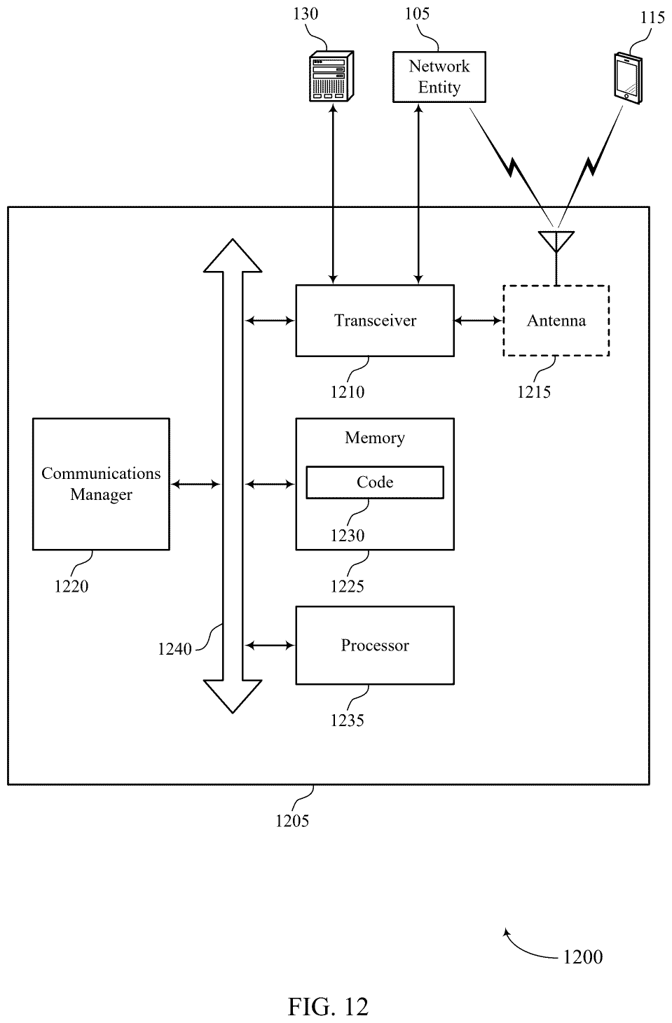

FIG. 12 shows a diagram of a system 1200 including a device 1205 that supports LP-WUS for RRC connected mode in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some examples, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some examples, the transceiver 1210 may include or be configured for coupling with one or more processors or one or more memory components that are operable to perform or support operations based on received or obtained information or signals, or to generate information or other signals for transmission or other outputting, or any combination thereof. In some examples, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting LP-WUS for RRC connected mode). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for transmitting a configuration message that indicates for a UE to monitor for one or more LP-WUSs (LP-WUSs). The communications manager 1220 is capable of, configured to, or operable to support a means for transmitting a LP-WUS that is indicative that the UE is to switch from use of a first radio to a second radio, where the LP-WUS also includes control information, and where the first radio is limited with respect to the second radio.

By including or configuring the communications manager 1220 in accordance with examples as described herein, the device 1205 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of LP-WUS for RRC connected mode as described herein, or the at least one processor 1235 and the at least one memory 1225 may be otherwise configured to, individually or collectively, perform or support such operations.

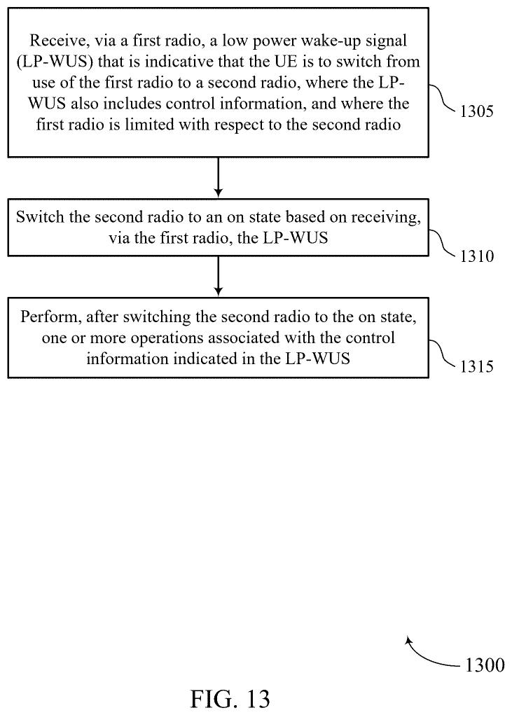

FIG. 13 shows a flowchart illustrating a method 1300 that supports LP-WUS for RRC connected mode in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving, via a first radio, a LP-WUS (LP-WUS) that is indicative that the UE is to switch from use of the first radio to a second radio, where the LP-WUS also includes control information, and where the first radio is limited with respect to the second radio. The operations of 1305 may be performed in accordance with examples as disclosed herein. In some examples, aspects of the operations of 1305 may be performed by an LP-WUR 725 as described with reference to FIG. 7.

At 1310, the method may include switching the second radio to an on state based on receiving, via the first radio, the LP-WUS. The operations of 1310 may be performed in accordance with examples as disclosed herein. In some examples, aspects of the operations of 1310 may be performed by a radio switching component 730 as described with reference to FIG. 7.

At 1315, the method may include performing, after switching the second radio to the on state, one or more operations associated with the control information indicated in the LP-WUS. The operations of 1315 may be performed in accordance with examples as disclosed herein. In some examples, aspects of the operations of 1315 may be performed by an LP-WUR 725 as described with reference to FIG. 7.

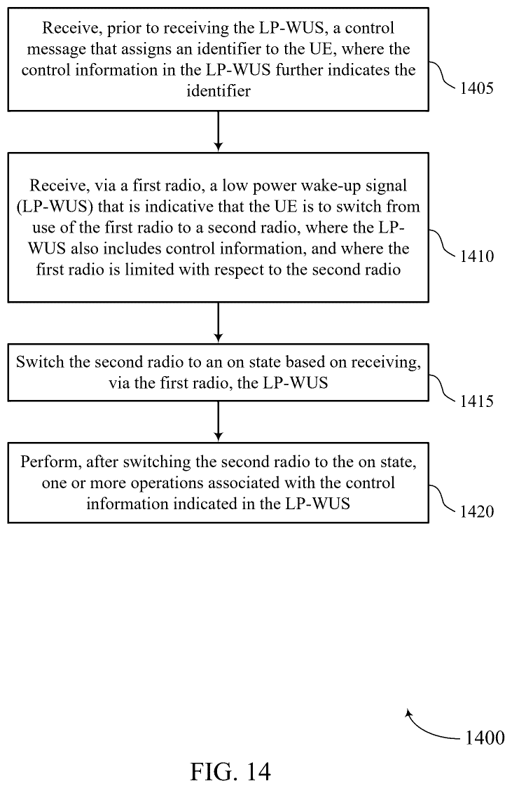

FIG. 14 shows a flowchart illustrating a method 1400 that supports LP-WUS for RRC connected mode in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving, prior to receiving the LP-WUS, a control message that assigns an identifier to the UE, where the control information in the LP-WUS further indicates the identifier. The operations of 1405 may be performed in accordance with examples as disclosed herein. In some examples, aspects of the operations of 1405 may be performed by an MR 735 as described with reference to FIG. 7.

At 1410, the method may include receiving, via a first radio, a LP-WUS (LP-WUS) that is indicative that the UE is to switch from use of the first radio to a second radio, where the LP-WUS also includes control information, and where the first radio is limited with respect to the second radio. The operations of 1410 may be performed in accordance with examples as disclosed herein. In some examples, aspects of the operations of 1410 may be performed by an LP-WUR 725 as described with reference to FIG. 7.

At 1415, the method may include switching the second radio to an on state based on receiving, via the first radio, the LP-WUS. The operations of 1415 may be performed in accordance with examples as disclosed herein. In some examples, aspects of the operations of 1415 may be performed by a radio switching component 730 as described with reference to FIG. 7.

At 1420, the method may include performing, after switching the second radio to the on state, one or more operations associated with the control information indicated in the LP-WUS. The operations of 1420 may be performed in accordance with examples as disclosed herein. In some examples, aspects of the operations of 1420 may be performed by an LP-WUR 725 as described with reference to FIG. 7.

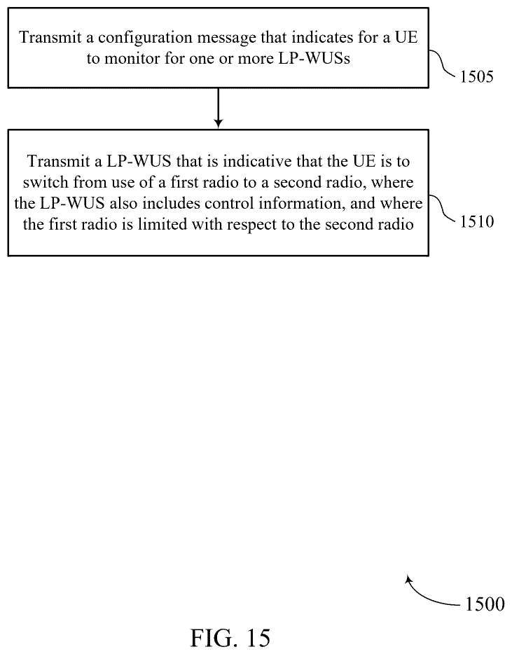

FIG. 15 shows a flowchart illustrating a method 1500 that supports LP-WUS for RRC connected mode in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include transmitting a configuration message that indicates for a UE to monitor for one or more LP-WUSs (LP-WUSs). The operations of 1505 may be performed in accordance with examples as disclosed herein. In some examples, aspects of the operations of 1505 may be performed by a control message signaling component 1125 as described with reference to FIG. 11.

At 1510, the method may include transmitting a LP-WUS that is indicative that the UE is to switch from use of a first radio to a second radio, where the LP-WUS also includes control information, and where the first radio is limited with respect to the second radio. The operations of 1510 may be performed in accordance with examples as disclosed herein. In some examples, aspects of the operations of 1510 may be performed by an LP-WUS transmission component 1130 as described with reference to FIG. 11.

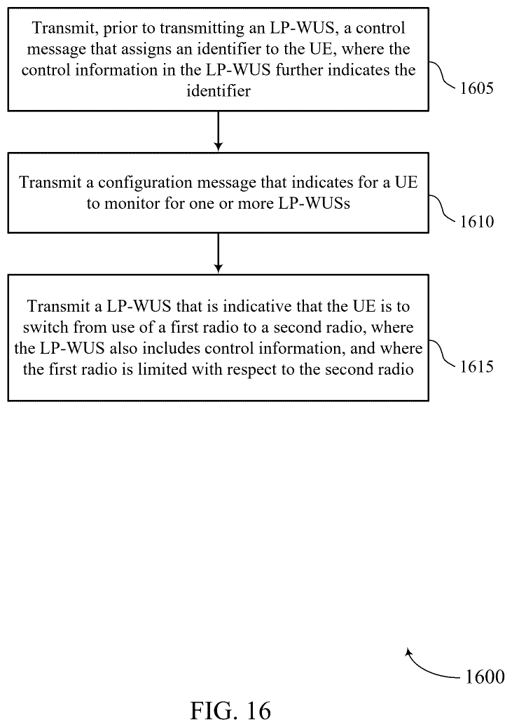

FIG. 16 shows a flowchart illustrating a method 1600 that supports LP-WUS for RRC connected mode in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include transmitting, prior to transmitting the LP-WUS, a control message that assigns an identifier to the UE, where the control information in the LP-WUS further indicates the identifier. The operations of 1605 may be performed in accordance with examples as disclosed herein. In some examples, aspects of the operations of 1605 may be performed by a control message signaling component 1125 as described with reference to FIG. 11.

At 1610, the method may include transmitting a configuration message that indicates for a UE to monitor for one or more LP-WUSs (LP-WUSs). The operations of 1610 may be performed in accordance with examples as disclosed herein. In some examples, aspects of the operations of 1610 may be performed by a control message signaling component 1125 as described with reference to FIG. 11.

At 1615, the method may include transmitting a LP-WUS that is indicative that the UE is to switch from use of a first radio to a second radio, where the LP-WUS also includes control information, and where the first radio is limited with respect to the second radio. The operations of 1615 may be performed in accordance with examples as disclosed herein. In some examples, aspects of the operations of 1615 may be performed by an LP-WUS transmission component 1130 as described with reference to FIG. 11.

The following provides an overview of aspects of the present disclosure:

Aspect 1: A method for wireless communications, at a UE comprising: receiving, via a first radio, a LP-WUS that is indicative that the UE is to switch from use of the first radio to a second radio, wherein the LP-WUS also includes control information, and wherein the first radio is limited with respect to the second radio; switching the second radio to an on state based at least in part on receiving, via the first radio, the LP-WUS; and performing, after switching the second radio to the on state, one or more operations associated with the control information indicated in the LP-WUS.

Aspect 2: The method of aspect 1, further comprising: receiving, prior to receiving the LP-WUS, a control message that assigns an identifier to the UE, wherein the control information in the LP-WUS further indicates the identifier.

Aspect 3: The method of aspect 2, wherein the identifier is exclusively assigned to the UE or to a set of UEs.

Aspect 4: The method of any of aspects 1 through 3, wherein the control information indicated in the LP-WUS comprises a wake-up bit that has one of a first value or a second value, the first value of the wake-up bit indicates for the UE to switch the second radio to the on state, and the second value of the wake-up bit indicates for the UE to switch the second radio to an off state.

Aspect 5: The method of any of aspects 1 through 4, further comprising: receiving a configuration message that indicates for the UE to monitor for one or more LP-WUSs using the second radio.

Aspect 6: The method of any of aspects 1 through 5, wherein the control information indicated in the LP-WUS comprises one or more CSI bits, the method further comprising: transmitting, as part of the one or more operations, a CSI report based at least in part on the control information indicated in the LP-WUS comprising the one or more CSI bits.

Aspect 7: The method of aspect 6, wherein the one or more CSI bits further indicate one or more time resources and one or more frequency resources for transmission of the CSI report.

Aspect 8: The method of any of aspects 1 through 7, wherein the control information indicated in the LP-WUS comprises one or more beam switch bits, the method further comprising: switching, as part of the one or more operations, from a first beam associated with communications with a network entity to a second beam associated with communications with the network entity.

Aspect 9: The method of aspect 8, wherein the one or more beam switch bits further indicate the second beam.

Aspect 10: The method of any of aspects 1 through 9, wherein the control information indicated in the LP-WUS comprises a synchronization signal transmission bit that indicates a synchronization signal to be transmitted by a network entity, the method further comprising: receiving, as part of the one or more operations, the synchronization signal from the network entity.

Aspect 11: The method of any of aspects 1 through 10, wherein the control information indicated in the LP-WUS comprises a sounding reference signal bit that indicates for the UE to transmit a sounding reference signal, the method further comprising: transmitting, as part of the one or more operations, the sounding reference signal based at least in part on the control information indicated in the LP-WUS comprising the sounding reference signal bit.

Aspect 12: The method of any of aspects 1 through 11, wherein the control information indicated in the LP-WUS comprises a physical downlink control channel order bit that indicates for the UE to transmit a physical random access channel message to a network entity, the method further comprising: transmitting, as part of the one or more operations, the physical random access channel message to the network entity based at least in part on the control information indicated in the LP-WUS comprising the physical downlink control channel order bit.

Aspect 13: The method of aspect 12, wherein the physical random access channel message comprises uplink timing synchronization information.

Aspect 14: The method of any of aspects 1 through 13, further comprising: switching, after performing the one or more operations, the second radio to an off state in accordance with an LP-WUS procedure.

Aspect 15: The method of aspect 14, wherein the UE switches the second radio to the off state after a configured duration in accordance with the LP-WUS procedure.

Aspect 16: The method of any of aspects 1 through 15, further comprising: receiving the control information as one or more information bits associated with one or more parameters of the LP-WUS, the one or more parameters comprising an on-off keying waveform, a spreading sequence for portions of the on-off keying waveform, a distribution of one or more time resources associated with the portions of the on-off keying waveform, a distribution of one or more frequency resources associated with the portions of the on-off keying waveform, or a combination thereof.

Aspect 17: The method of any of aspects 1 through 16, wherein the first radio is a LP-WUR and the second radio is a MR.

Aspect 18: A method for wireless communications, at a network entity, comprising: transmitting a configuration message that indicates for a UE to monitor for one or more LP-WUSs; and transmitting a LP-WUS that is indicative that the UE is to switch from use of a first radio to a second radio, wherein the LP-WUS also includes control information, and wherein the first radio is limited with respect to the second radio.

Aspect 19: The method of aspect 18, further comprising: transmitting, prior to receiving the LP-WUS, a control message that assigns an identifier to the UE, wherein the control information in the LP-WUS further indicates the identifier.

Aspect 20: The method of aspect 19, wherein the identifier is exclusively assigned to the UE or to a set of UEs.

Aspect 21: The method of any of aspects 18 through 20, wherein the control information indicated in the LP-WUS comprises a wake-up bit that has one of a first value or a second value, the first value of the wake-up bit indicates for the UE to switch the second radio to an on state, and the second value of the wake-up bit indicates for the UE to switch the second radio to an off state.

Aspect 22: The method of any of aspects 18 through 21, wherein the control information indicated in the LP-WUS comprises one or more CSI bits, the method further comprising: receiving a CSI report based at least in part on the control information indicated in the LP-WUS comprising the one or more CSI bits.

Aspect 23: The method of aspect 22, wherein the one or more CSI bits further indicate one or more time resources and one or more frequency resources for transmission at the UE of the CSI report.

Aspect 24: The method of any of aspects 18 through 23, wherein the control information indicated in the LP-WUS comprises one or more beam switch bits that indicates for the UE to switch from a first beam associated with communications with a network entity to a second beam associated with communications with the network entity.

Aspect 25: The method of aspect 24, wherein the one or more beam switch bits further indicate the second beam.

Aspect 26: The method of any of aspects 18 through 25, wherein the control information indicated in the LP-WUS comprises a synchronization signal transmission bit that indicates a synchronization signal to be transmitted by a network entity, the method further comprising: transmitting, to the UE, the synchronization signal.

Aspect 27: The method of any of aspects 18 through 26, wherein the control information indicated in the LP-WUS comprises a sounding reference signal bit that indicates for the UE to transmit a sounding reference signal, the method further comprising: receiving the sounding reference signal based at least in part on the control information indicated in the LP-WUS comprising the sounding reference signal bit.

Aspect 28: The method of any of aspects 18 through 27, wherein the control information indicated in the LP-WUS comprises a physical downlink control channel order bit that indicates for the UE to transmit a physical random access channel message to the network entity, the method further comprising: receiving, from the UE, the physical random access channel message based at least in part on the control information indicated in the LP-WUS comprising the physical downlink control channel order bit.

Aspect 29: The method of aspect 28, wherein the physical random access channel message comprises uplink timing synchronization information.

Aspect 30: The method of any of aspects 18 through 29, further comprising: transmitting the control information as one or more information bits associated with one or more parameters of the LP-WUS, the one or more parameters comprising an on-off keying waveform, a spreading sequence for portions of the on-off keying waveform, a distribution of one or more time resources associated with the portions of the on-off keying waveform, a distribution of one or more frequency resources associated with the portions of the on-off keying waveform, or a combination thereof.

Aspect 31: The method of any of aspects 18 through 30, wherein the first radio is a LP-WUR and the second radio is a MR.

Aspect 32: A UE for wireless communications, comprising one or more memories storing processor-executable code, and one or more processors coupled with the one or more memories and individually or collectively operable to execute the code to cause the UE to perform a method of any of aspects 1 through 17.

Aspect 33: A UE for wireless communications, comprising at least one means for performing a method of any of aspects 1 through 17.

Aspect 34: A non-transitory computer-readable medium storing code for wireless communications, the code comprising instructions executable by one or more processors to perform a method of any of aspects 1 through 17.

Aspect 35: A network entity for wireless communications, comprising one or more memories storing processor-executable code, and one or more processors coupled with the one or more memories and individually or collectively operable to execute the code to cause the network entity to perform a method of any of aspects 18 through 31.

Aspect 36: A network entity for wireless communications, comprising at least one means for performing a method of any of aspects 18 through 31.

Aspect 37: A non-transitory computer-readable medium storing code for wireless communications, the code comprising instructions executable by one or more processors to perform a method of any of aspects 18 through 31.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, via a first radio, a low power wake-up signal (LP-WUS) that is indicative that the UE is to switch from use of the first radio to a second radio, wherein the LP-WUS also includes control information, and wherein the first radio is limited with respect to the second radio; and
perform one or more operations associated with the control information indicated in the LP-WUS.

2. The UE of claim 1, wherein the one or more processors are individually or collectively further operable to execute the code to cause the UE to:
switch the second radio to an on state based at least in part on receiving, via the first radio, the LP-WUS.

3. The UE of claim 1, wherein the one or more processors are individually or collectively further operable to execute the code to cause the UE to:
receive, prior to receiving the LP-WUS, a control message that assigns an identifier to the UE, wherein the control information in the LP-WUS further indicates the identifier.

4. The UE of claim 3, wherein the identifier is exclusively assigned to the UE or to a set of UEs.

5. The UE of claim 1, wherein:
the control information indicated in the LP-WUS comprises a wake-up bit that has one of a first value or a second value,
the first value of the wake-up bit indicates for the UE to switch the second radio to an on state, and
the second value of the wake-up bit indicates for the UE to switch the second radio to an off state.

6. The UE of claim 1, wherein the one or more processors are individually or collectively further operable to execute the code to cause the UE to:
receive a configuration message that indicates for the UE to monitor for one or more LP-WUSs using the second radio.

7. The UE of claim 1, wherein the control information indicated in the LP-WUS comprises one or more channel state information bits, and the one or more processors are individually or collectively further operable to execute the code to cause the UE to:
transmit, as part of the one or more operations, a channel state information report based at least in part on the control information indicated in the LP-WUS comprising the one or more channel state information bits.

8. The UE of claim 7, wherein the one or more channel state information bits further indicate one or more time resources and one or more frequency resources for transmission of the channel state information report.

9. The UE of claim 1, wherein the control information indicated in the LP-WUS comprises one or more beam switch bits, and the one or more processors are individually or collectively further operable to execute the code to cause the UE to:
switching, as part of the one or more operations, from a first beam associate with communications with a network entity to a second beam associated with communications with the network entity.

10. The UE of claim 9, wherein the one or more beam switch bits further indicate the second beam.

11. The UE of claim 1, wherein the control information indicated in the LP-WUS comprises a synchronization signal transmission bit that indicates a synchronization signal to be transmitted by a network entity, and the one or more processors are individually or collectively further operable to execute the code to cause the UE to:
receive, as part of the one or more operations, the synchronization signal from the network entity.

12. The UE of claim 1, wherein the control information indicated in the LP-WUS comprises a sounding reference signal bit that indicates for the UE to transmit a sounding reference signal, and the one or more processors are individually or collectively further operable to execute the code to cause the UE to:
transmit, as part of the one or more operations, the sounding reference signal based at least in part on the control information indicated in the LP-WUS comprising the sounding reference signal bit.

13. The UE of claim 1, wherein the control information indicated in the LP-WUS comprises a physical downlink control channel order bit that indicates for the UE to transmit a physical random access channel message to a network entity, and the one or more processors are individually or collectively further operable to execute the code to cause the UE to:
transmit, as part of the one or more operations, the physical random access channel message to the network entity based at least in part on the control information indicated in the LP-WUS comprising the physical downlink control channel order bit.

14. The UE of claim 13, wherein:
the physical random access channel message comprises uplink timing synchronization information.

15. The UE of claim 1, wherein the one or more processors are individually or collectively further operable to execute the code to cause the UE to:
switching, after performing the one or more operations, the second radio to an off state in accordance with an LP-WUS procedure.

16. The UE of claim 15, wherein the UE switches the second radio to the off state after a configured duration in accordance with the LP-WUS procedure.

17. The UE of claim 1, wherein the one or more processors are individually or collectively further operable to execute the code to cause the UE to:
receive the control information as one or more information bits associated with one or more parameters of the LP-WUS, the one or more parameters comprising an on-off keying waveform, a spreading sequence for portions of the on-off keying waveform, a distribution of one or more time resources associated with the portions of the on-off keying waveform, a distribution of one or more frequency resources associated with the portions of the on-off keying waveform, or a combination thereof.

18. The UE of claim 1, wherein the first radio is a low power wake-up receiver (LP-WUR) and the second radio is a main receiver (MR).

19. A method for wireless communications, at a user equipment (UE) comprising:
receiving, via a first radio, a low power wake-up signal (LP-WUS) that is indicative that the UE is to switch from use of the first radio to a second radio, wherein the LP-WUS also includes control information, and wherein the first radio is limited with respect to the second radio; and
performing one or more operations associated with the control information indicated in the LP-WUS.

20. A non-transitory computer-readable medium storing code at a user equipment (UE) for wireless communications, the code comprising instructions executable by one or more processors to:
receive, via a first radio, a low power wake-up signal (LP-WUS) that is indicative that the UE is to switch from use of the first radio to a second radio, wherein the LP-WUS also includes control information, and wherein the first radio is limited with respect to the second radio; and
perform one or more operations associated with the control information indicated in the LP-WUS.
